(19) United States
(12) Patent Application Publication
(10) Pub. No.: US 2008/0179076 A1
(43) Pub. Date: Jul. 31, 2008

(54) METHOD FOR PREVENTING SIPHONING EFFECT IN TERMINAL AND TERMINAL MANUFACTURED USING THE SAME

(75) Inventor: Ted JU, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD

(21) Appl. No.: 12/019,111

(22) Filed: Jan. 24, 2008

(30) Foreign Application Priority Data
Jan. 26, 2007 (CN) 200710026520.X

(51) Int. Cl. H01B 5/00; B05D 5/00; C25D 7/00

(52) U.S. Cl. 174/126.2; 427/123; 205/291; 205/181

(57) ABSTRACT

The invention relates to a method for preventing siphoning effect in a terminal. The terminal of the invention comprises a conductive portion connected to an external component by a solder and a connecting portion extended to form the conductive portion. An exposed and easily oxidized copper is attached on the surface of the connecting portion, and the copper can be further oxidized to form oxide of copper. Since the copper is attached on the connecting portion of the terminal, and the copper can be oxidized to form oxide of copper, the oxide of copper, such as copper oxide, can prevent the siphoning of the solder from the conductive portion to the connecting portion during the soldering process. Accordingly, the solder can be saved, and the phenomenon of false welding can be avoided, such that the quality of soldering can be maintained well and the production cost can be reduced.

### BACKGROUND OF THE INVENTION

1. Field of the Invention

The present invention relates to a method for preventing siphoning effect in a terminal and the terminal is manufactured using the method.

2. Description of the Prior Art

Currently, an electrical connector is usually used to electrically connect an electronic component, such as a chip module or an interface card, to a printed circuit board, and such electrical connector is usually equipped with conductive terminals. Moreover, one end of the conductive terminal (i.e. the contact portion) is electrically connected to the electronic component and the other end (i.e. the soldering end) is soldered to the printed circuit board, so as to fulfill the electrical connection between the electronic component and the printed circuit board.

A current method of soldering a conductive terminal onto a printed circuit board including following steps: planting a solder ball onto the soldering end of the conductive terminal; melting the solder ball, and soldering the conductive terminal onto the printed circuit board through the melted solder ball. Since the surface of the conductive terminal is electroplated with gold and very fine part can be easily generated on the gold-electroplated layer, siphoning effect will be generated during the process of soldering the conductive terminal, and the melted solder will be siphoned from the soldering end of the conductive terminal to the contact portion of the conductive terminal, which in turn leads to massive loss of the solder and the so-called false welding. The aforesaid effect will seriously affect the electrical connection between the conductive terminal and the printed circuit board.

Therefore, the invention provides a new conductive terminal for preventing the siphoning effect, so as to solve the aforesaid problems.

### SUMMARY OF THE INVENTION

A scope of the invention is to provide a method for preventing siphoning effect during the process of welding a terminal onto a printed circuit board and the terminal manufactured using the method.

In order to realize the aforesaid scope, the invention provides a method for preventing siphoning effect during the process of welding a terminal onto a printed circuit board. The terminal comprises a conductive portion connected to an external component by a solder and a connecting portion extending from the conductive portion. Moreover, a copper coating, which is exposed and easily oxidized, is electroplated on the surface of the connecting portion and the copper can be further oxidized to form a copper oxide.

Furthermore, the terminal of the invention comprises a connecting portion and a conductive portion, wherein the conductive portion extends from the connecting portion and the conductive portion can be connected to the external component by a solder. Moreover, a copper, which is exposed and easily oxidized, is electroplated on the connecting portion.

Since the copper, which is exposed and easily oxidized, is electroplated on the connecting portion of the terminal of the invention, and a copper oxide will be formed outside surface of the connecting portion which can prevent the siphoning of solder from the conductive portion of the terminal to the connecting portion of the terminal during the process of soldering the terminal. Therefore, it is very helpful in saving solder, in preventing the occurrence of missing solder, in ensuring the soldering quality, and in facilitating the saving of production cost.

The advantage and spirit of the invention may be understood by the following recitations together with the appended drawings.

### BRIEF DESCRIPTION OF THE DRAWINGS

FIG. 1 is a schematic diagram illustrating parts of the terminal of the invention.

### DETAILED DESCRIPTION OF THE INVENTION

In the following, the attached figures will be associated to describe the method of the invention capable of preventing the occurrence of siphoning effect in the terminal and the terminal is manufactured using the method.

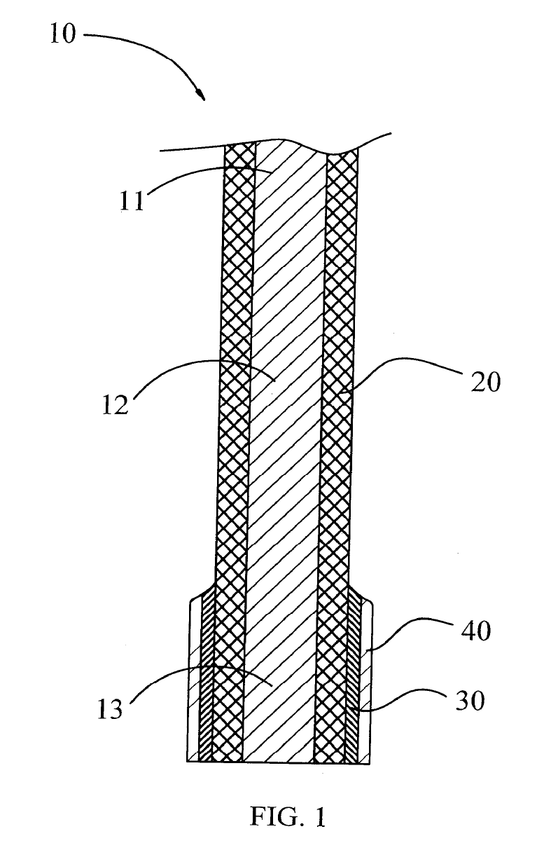

Please refer to FIG. 1. FIG. 1 is a schematic diagram illustrating parts of the terminal 10 in the present invention capable of preventing siphoning effect. The terminal 10 includes a conductive portion 13 soldered to an external component (such as a printed circuit board) by a solder (not shown in FIG. 1), and a connecting portion 12 extending from the conductive portion 13. The connecting portion 12 further extends to form a contact portion 11 (in FIG. 1, only part of the contact portion 11 is shown). The contact portion 11 is used to electrically contact a chip module (not shown in FIG. 1), an interface card (not shown in FIG. 1), or other electronic components (not shown in FIG. 1) to a printed circuit board (not shown in FIG. 1). The surface of the connecting portion 12 and the conductive portion 13 is electroplated with a copper coating which is easily oxidized (Certainly, there are other ways, for example, performing activation treatment directly on the connecting portion 12). Then, a nickel coating 30 is electroplated on the outside surface of the copper coating 20 which is electroplated on the conductive portion 13, and a gold coating 40 is electroplated on the outside surface of the nickel coating 30. The copper coating 20 on the connecting portion 12 is oxidized to form a copper oxide film which can prevent the siphoning of the melted solder from the conductive portion 13 of the terminal 10 to the connecting portion 12 of the terminal 10 during the soldering process. Accordingly, the solder can be saved, the false welding can be prevented, and the soldering quality can be ensured.

Please refer to FIG. 1. The terminal 10 is manufactured through the aforesaid method. The material of the main body of the terminal 10 is copper generally. The terminal 10 includes a conductive portion 13 welded to an external component by a solder, a connecting portion 12 extending from the conductive portion 13, and a contact portion 11 extending from the connecting portion 12. The main body of the conductive portion 13 is coated with three metal layers. The first metal layer is copper 20, the second metal layer is nickel 30, and the third metal layer is gold 40. The first metal layer is also formed outside the connecting portion 12 and is oxidized to copper oxide which can prevent the siphoning of melted solder from the conductive portion 13 of the terminal 10 to the connecting portion 12 of the terminal 10 during the soldering process. Accordingly, the solder can be saved, the missing solder can be prevented, and the soldering quality can be ensured.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A terminal, comprising:
a connecting portion defining an easily oxidized copper whereon, wherein the easily oxidized copper is exposed, and
a conductive portion extending from the connecting portion and connected to an external component by a solder.

2. The terminal of claim 1, wherein the material of a main body of the terminal is a general copper and the easily oxidized copper is attached on the general copper.

3. The terminal of claim 1, wherein at least two metal layers are attached on the conductive portion of the terminal.

4. The terminal of claim 1, wherein two metal layers are attached on the conductive portion of the terminal, wherein the first metal layer is nickel and the second metal layer is gold attached on an exterior of nickel.

5. The terminal of claim 1, wherein three metal layers are attached on the conductive portion of the terminal, wherein the first metal layer is copper, the second metal layer is nickel, and the third metal layer is gold.

6. The terminal of claim 5, wherein the first metal layer is also attached on the connecting portion of the terminal.

7. A method for preventing siphoning effect in a terminal, the terminal having a conductive portion connected to an external component by a solder and a connecting portion extended from the conductive portion, the method comprising the steps of: attaching an easily oxidized copper on a surface of the connecting portion, and oxidizing the copper to form an oxide of copper.

8. The method of claim 7, wherein the step of attaching the easily oxidized copper comprises electroplating the easily oxidized copper on the material of the main body of the connecting portion.

9. The method of claim 7, further comprising electroplating nickel on a surface of the conductive portion and electroplating gold on a surface of nickel.

10. The method of claim 7, further comprising entirely electroplating a layer of easily oxidized copper on a surface of the terminal, electroplating nickel on a surface of the conductive portion, and electroplating gold on a surface of nickel.
